(19) United States
(12) Patent Application Publication
(10) Pub. No.: US 2025/0305614 A1
(43) Pub. Date: Oct. 2, 2025

(54) HOSE BARB EFFECTING REDUCTIONS IN PRESSURE LOSS

(71) Applicant: Nelson Irrigation Corporation, Walla Walla, WA (US)

(72) Inventors: Craig B. NELSON, Walla Walla, WA (US); Derek K. UEMURA, Dayton, WA (US); Tanner R. DRUFFEL, Walla Walla, WA (US)

(21) Appl. No.: 18/622,303

(22) Filed: Mar. 29, 2024

(51) Int. Cl. F16L 41/08

(52) U.S. Cl. CPC F16L 41/08

(57) ABSTRACT

A barb is disposed at an end of a flexible tube for insertion through an opening in an irrigation hose wall. The barb includes a distal end with a first diameter, an exterior wall extending from the distal end, and a shoulder disposed at a proximal end of the exterior wall that seals against an interior surface of the irrigation hose wall. The exterior wall tapers outward from the distal end to the shoulder such that the shoulder has a second diameter larger than the first diameter. A slot defined through the exterior wall is configured to reduce pressure losses through the barb.

### CROSS-REFERENCES TO RELATED APPLICATIONS

(Not Applicable)

### STATEMENT REGARDING FEDERALLY SPONSORED RESEARCH OR DEVELOPMENT

(Not Applicable)

### BACKGROUND

The invention relates to stake and feed tube assemblies for irrigation and, more particularly, to a modified barb in such an assembly that reduces pressure losses through the barb.

Stake and feed tube assemblies typically include a barb, a 10 mm PVC (polyvinyl chloride) tube, and an adapter that attaches to a sprinkler. The entire assembly is attached by inserting the barb into a 1- to 1.5-inch PE (polyethylene) supply hose. The PVC tube lengths usually are 30-inch and 48-inch lengths, and the assemblies are spaced 20-40 feet apart. This type of assembly is mainly used with orchard irrigation, but can be adapted for row crops, sod, or any other crop that requires the use of sprinklers. The assemblies are generally not removed once inserted into the PE supply hose.

The barb serves to provide a water inlet for the assembly and secure the feed tube to the PE supply hose. Once inserted, the back of the barb face or barb shoulder seals against inside wall of the PE tube/supply hose. The barb also serves to secure the feed tube to the PE supply hose and allows for movement of the assembly due to shrinking/expansion resulting from temperature variations.

Excessive pressure loss has been measured through the feed tube. FIG. 2 shows CFD (computational fluid dynamics) analysis on an existing fitting assembly. As shown, most of the pressure loss occurs through the barb.

From a hydraulics standpoint, a straight barb entrance can be associated with unfavorable entrance conditions. It would thus be desirable to modify the barb to reduce entrance (pressure) losses.

### SUMMARY

The modified barb according to the described embodiments incorporates structure to reduce pressure losses. In some embodiments, a slit is provided in the barb. The slit may be tapered and/or the edges may be radiused. The height of the barb may also be reduced, which thereby increases the inside diameter of the barb at its distal end.

In an exemplary embodiment, a barb disposed at an end of a flexible tube for insertion through an opening in an irrigation hose wall includes a distal end with a first diameter, an exterior wall extending from the distal end, and a shoulder disposed at a proximal end of the exterior wall that seals against an interior surface of the irrigation hose wall. The exterior wall tapers outward from the distal end to the shoulder such that the shoulder has a second diameter larger than the first diameter. A slot defined through the exterior wall is configured to reduce pressure losses through the barb.

A depth of the slot may be greater than half of a height of the barb. The slot may taper inward from the distal end, which taper may be at an angle of 30 degrees. The distal end may include radiused edges. A height of the exterior wall may be smaller than a width of the slot at a shoulder end of the barb.

A height of the exterior wall may be smaller than a width of the slot at a shoulder end of the barb. The height of the exterior wall may be configured such that an inside diameter of the distal end may be increased greater than 30 percent as compared with a standard barb.

In some embodiments, the slot may be 0.15 inches wide×0.133 inches deep.

In another exemplary embodiment, a stake and feed tube assembly for a rotary sprinkler includes a flexible supply tube, an adapter to which a sprinkler head is connectable in fluid communication with the flexible supply tube, and a stake supporting the adapter. The flexible supply tube includes the barb of the described embodiments at a distal end for insertion through an opening in an irrigation hose wall.

### BRIEF DESCRIPTION OF THE DRAWINGS

These and other aspects and advantages will be described in detail with reference to the accompanying drawings, in which:

FIG. 1 shows an exemplary stake and feed tube assembly;

FIG. 2 shows a computational fluid dynamics analysis on an existing fitting assembly;

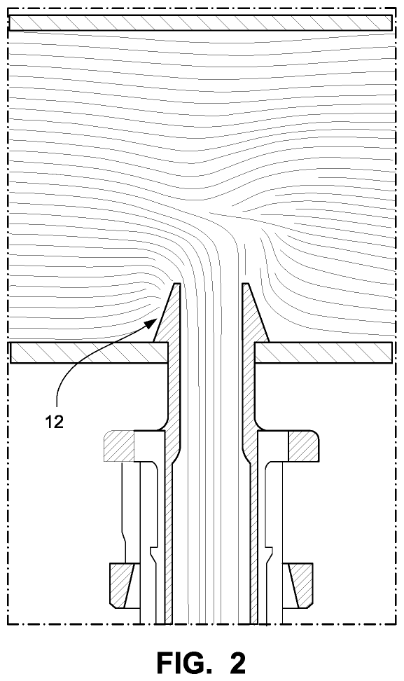

FIGS. 3-5 show exemplary configurations of a slot in the barb for reducing pressure losses through the barb;

FIG. 6 shows relative pressure losses from a conventional barb and from the exemplary slot configurations in the barbs shown in FIGS. 3-5; and

FIG. 7 shows assembly installation instructions for the rotator feed tube assembly.

### DETAILED DESCRIPTION

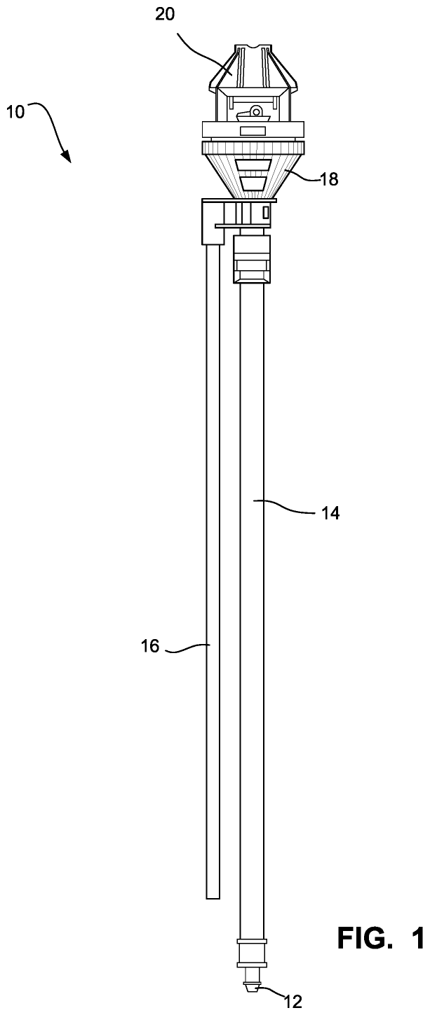

With reference to FIG. 1, a stake and feed tube assembly 10 includes a barb 12 at an end of a flexible PVC tube 14, a stake 16, and an adapter 18 to which a sprinkler head 20 is mounted. The barb 12 is inserted into a 1-1.5 inch PE supply hose, which supplies water to the sprinkler head 20 via the PVC tube 14.

Existing barbs extend into the stream path and cause unwanted turbulence. Additionally, sharp edges at the barb inlet provide undesirable entrance conditions.

The existing barb is part conical and includes a distal end with a first narrow diameter, an outwardly tapered exterior wall, and a shoulder at a proximal end of the exterior wall that seals against an interior surface of the irrigation hose wall. In some applications, the inside diameter of the existing barb is 0.22 inches at its distal end and 0.26 inches at its proximal end.

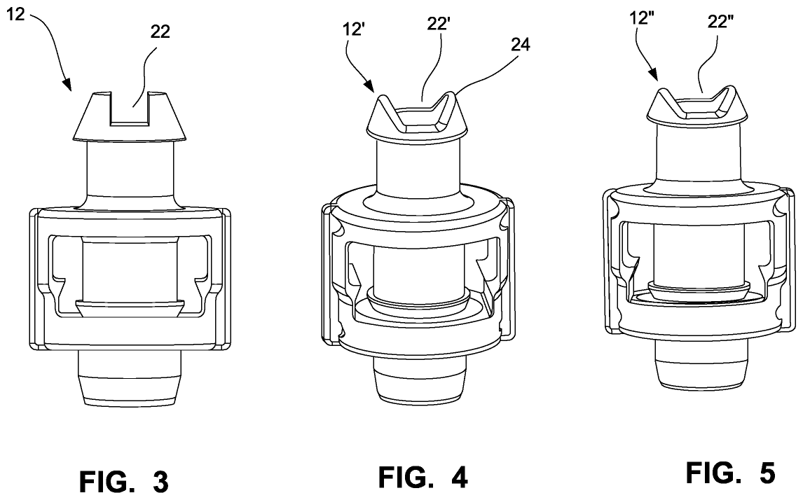

FIG. 3 shows a modification of the barb 12 including a slot 22 through the part conical shape that is configured to reduce pressure losses through the barb 12. As shown, a depth of the slot 22 is greater than half of a height of the barb 12. In one application, the slot is 0.15 inches wide by 0.133 inches deep. The slot 22 may be cut into the nose of the barb 12 or machined into the barb 12.

FIG. 4 shows a variation of the barb 12′ where the slot 22′ tapers inward from the distal end. In some embodiments, the slot 22′ tapers inward at an angle of 30 degrees. In the configuration shown in FIG. 4, the distal end of the barb 12′ also includes radiused edges 24. The slot 22′ shown in FIG. 4 is generally the same as the slot 22 shown in FIG. 3 but with the 30-degree taper and the radiused edges 24.

FIG. 5 shows yet another exemplary configuration of the barb 12″ where the slot 22″ has a reduced snout height, which results in an increased inside diameter at its distal end. For example, a height of the exterior wall of the barb 12″ may be smaller than a width of the slot 22″ at a shoulder end of the barb 12″. With the reduction in snout height, an inside diameter of the barb 12″ in FIG. 5 may be increased to 0.29 inches, which amounts to greater than a 30 percent increase in the size of the inside diameter as compared to the existing part conical barb.

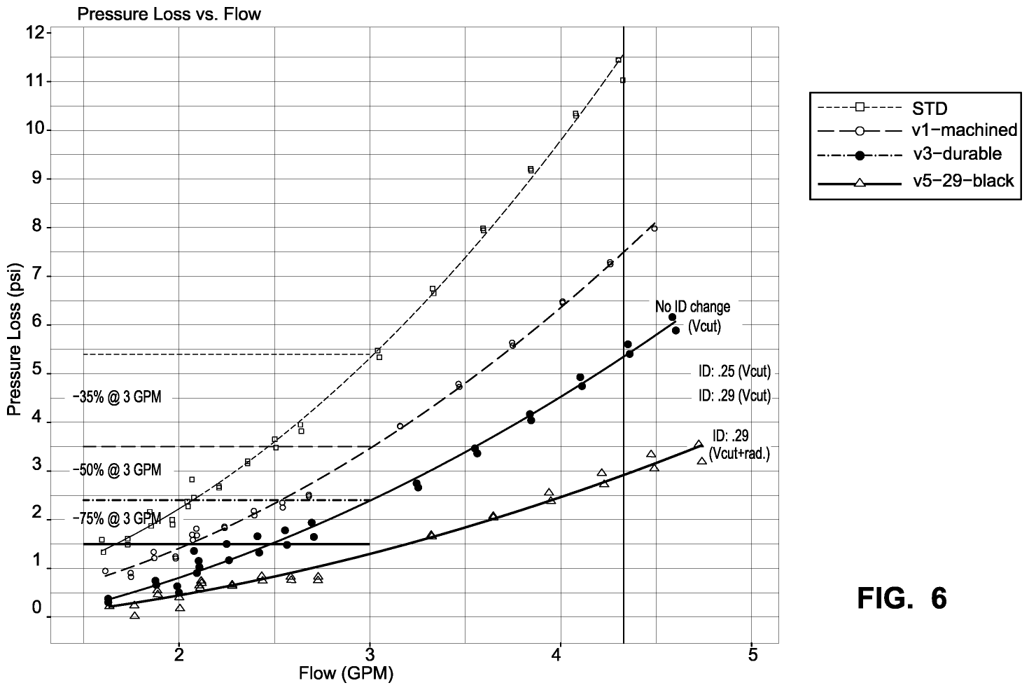

FIG. 6 shows the relative pressure losses from the modified barb according to the described embodiments. Testing was conducted using identical test fixtures. To calculate the difference in pressure losses, the new pressure losses from the modifications were subtracted from the standard barb assembly losses. A first line 26 shows pressure losses using the existing unmodified barb. A second line 28 shows the pressure losses with the barb shown in FIG. 3; a third line 30 shows the pressure losses with the barb shown in FIG. 4; and a fourth line 32 shows the pressure losses with the barb shown in FIG. 5. The reduction in measured pressure loss relative to the existing conventional barb was 35, 50, and 75 percent, for the variations shown in FIGS. 3, 4 and 5, respectively.

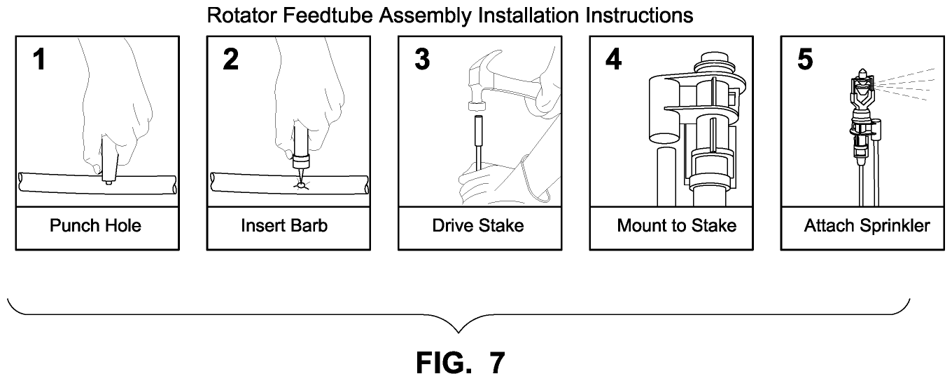

FIG. 7 shows exemplary installation instructions for a rotator feed tube assembly. In window 1, a hole is punched into the PE supply hose, and in window 2, the barb 12, 12′, 12″ is inserted into the punched hole. The stake 16 is driven into the ground in window 3, and the adapter 18 is secured on the stake in window 4. In window 5, the sprinkler head 20 is secured on the adapter.

The modified barb of the described embodiments reduces pressure losses as compared to the existing barb, resulting in better flow through the sprinkler. Better flow equates to more even and accurate water distribution and improved irrigation.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A barb disposed at an end of a flexible tube for insertion through an opening in an irrigation hose wall, the barb comprising:
a distal end with a first diameter;
an exterior wall extending from the distal end;
a shoulder disposed at a proximal end of the exterior wall that seals against an interior surface of the irrigation hose wall, wherein the exterior wall tapers outward from the distal end to the shoulder such that the shoulder has a second diameter larger than the first diameter; and
a slot defined through the exterior wall, wherein the slot is configured to reduce pressure losses through the barb.

2. A barb according to claim 1, wherein a depth of the slot is greater than half of a height of the barb.

3. A barb according to claim 2, wherein the slot tapers inward from the distal end.

4. A barb according to claim 3, wherein the slot tapers inward at an angle of 30 degrees.

5. A barb according to claim 3, wherein the distal end comprises radiused edges.

6. A barb according to claim 5, wherein a height of the exterior wall is smaller than a width of the slot at a shoulder end of the barb.

7. A barb according to claim 1, wherein the slot tapers inward from the distal end.

8. A barb according to claim 7, wherein the distal end comprises radiused edges.

9. A barb according to claim 1, wherein a height of the exterior wall is smaller than a width of the slot at a shoulder end of the barb.

10. A barb according to claim 9, wherein the height of the exterior wall is configured such that an inside diameter of the distal end is increased greater than 30 percent as compared with a standard barb.

11. A barb according to claim 1, wherein the slot is 0.15 inches wide×0.133 inches deep.

12. A stake and feed tube assembly for a rotary sprinkler, comprising:
a flexible supply tube;
an adapter to which a sprinkler head is connectable in fluid communication with the flexible supply tube; and
a stake supporting the adapter,
wherein the flexible supply tube includes a barb at a distal end for insertion through an opening in an irrigation hose wall, the barb comprising:
a distal end with a first diameter,
an exterior wall extending from the distal end,
a shoulder disposed at a proximal end of the exterior wall that seals against an interior surface of the irrigation hose wall, wherein the exterior wall tapers outward from the distal end to the shoulder such that the shoulder has a second diameter larger than the first diameter, and
a slot defined through the exterior wall, wherein the slot is configured to reduce pressure losses through the barb into the flexible supply tube.

13. A stake and feed tube assembly according to claim 12, wherein a depth of the slot is greater than half of a height of the barb.

14. A stake and feed tube assembly according to claim 13, wherein the slot tapers inward from the distal end.

15. A stake and feed tube assembly according to claim 14, wherein the distal end comprises radiused edges.

16. A stake and feed tube assembly according to claim 15, wherein a height of the exterior wall is smaller than a width of the slot at a shoulder end of the barb.

17. A stake and feed tube assembly according to claim 12, wherein the slot tapers inward from the distal end.

18. A stake and feed tube assembly according to claim 17, wherein the distal end comprises radiused edges.

19. A stake and feed tube assembly according to claim 12, wherein a height of the exterior wall is smaller than a width of the slot at a shoulder end of the barb.
